(19) United States
(12) Patent Application Publication
(10) Pub. No.: US 2009/0110856 A1
(43) Pub. Date: Apr. 30, 2009

(54) ADHESIVE ARTICLE

(76) Inventors: Raghuram Gummaraju, Kendall Park, NJ (US); Thomas G. Savino, Northville, MI (US); Limei Lu, Canton, MI (US); Barry K. Speronello, Belle Mead, NJ (US); Donald C. Mente, Grosse Ile, MI (US); Daniel A. Navarre, Newport, MI (US)

Correspondence Address: HOWARD & HOWARD ATTORNEYS PLLC;BASF SE, 450 West Fourth Street, Royal Oak, MI, 48067, US

(21) Appl. No.: 12/244,442

(22) Filed: Oct. 2, 2008

Related U.S. Application Data
(60) Provisional application No. 60/977,167, filed on Oct. 3, 2007.

(51) Int. Cl. B32B 1/06; B32B 27/06

(52) U.S. Cl. 428/35.7; 428/34.1

(57) ABSTRACT

An adhesive article comprises a rupturable container and a moisture-curable composition. The rupturable container defines an enclosed cavity. The moisture-curable composition is disposed within the enclosed cavity. The moisture-curable composition comprises a prepolymer comprising the reaction product of an isocyanate component and an isocyanate-reactive component. The moisture-curable composition further comprises a catalyst component and an acid halide component. The adhesive article may be used in various industries and for various applications, such as for construction and remodeling of commercial, industrial, and residential buildings.

### CROSS REFERENCE TO RELATED APPLICATIONS

This application claims the benefit of U.S. Provisional Patent Application Ser. No. 60/977,167, filed on Oct. 3, 2007, which is incorporated herewith in its entirety.

### FIELD OF THE INVENTION

The present invention generally relates to an adhesive article and, more specifically, to an adhesive article comprising a rupturable container and a moisture-curable composition disposed therein.

### DESCRIPTION OF THE RELATED ART

Adhesive articles can be used during construction and remodeling of residential buildings. Specifically, adhesive articles serve as fasteners between two or more building components. Conventional adhesive articles often comprise a pressure-dispensing cartridge device, such as those used in caulking, or a rupturable container (which ruptures under pressure), such as a glass vial, with an adhesive composition, such as a liquid cyanoacrylate adhesive, disposed therein. In one example of use of the articles, during construction of a house, an adhesive article is set on top a floor joist. Next, a piece of flooring or sub-flooring is placed on top the floor joist such that the adhesive article is disposed, i.e., sandwiched, between the floor joist and the piece of flooring. Due to the weight of the piece of flooring, weight of foot traffic, or piercing by a fastener such as a nail, the adhesive article ruptures such that the adhesive composition flows out. The adhesive composition cures upon exposure to air to bond the piece of flooring to the floor joist. To further fasten the building components, other fasteners known in the construction art, such as screws and nails, are driven through the building components.

However, the aforementioned adhesive articles suffer from one or more inadequacies. Specifically, the adhesive composition in the adhesive articles prematurely cures during manufacture, handling, and use, the adhesive articles have shortened shelf life and stability issues, and there are adhesion strength issues when the adhesive articles of the prior art are used. Premature cure is especially a problem with adhesive compositions applied by caulk guns. For example, if such an adhesive composition is applied as a bead to a floor joist and allowed to sit for some time prior to placing a piece of flooring over the bead, the bead (now cured) can cause the flooring to become uneven or beveled over the floor joist. In addition, many of the adhesive articles fail to uniformly rupture, thereby causing poor distribution of the adhesive composition, which lowers overall adhesion strength provided by the adhesive article. Accordingly, there remains an opportunity to provide an adhesive article that provides excellent adhesion strength, and that has excellent shelf life and stability. There also remains an opportunity to provide an adhesive article, more specifically, a rupturable container, that has excellent rupture characteristics, excellent distribution characteristics, and excellent protection for an adhesive composition disposed therein. In addition, there remains an opportunity to provide an adhesive article that is easy to manufacture, ship, store, and handle.

### SUMMARY OF THE INVENTION AND ADVANTAGES

The present invention provides an adhesive article. The adhesive article comprises a rupturable container. The rupturable container defines an enclosed cavity. A moisture-curable composition is disposed within the enclosed cavity. The moisture-curable composition comprises a prepolymer comprising the reaction product of an isocyanate component and an isocyanate-reactive component. The moisture-curable composition further comprises a catalyst component and an acid halide component.

The adhesive article of the present invention provides a unique combination of the rupturable container and a moisture-curable composition disposed therein. The adhesive article has excellent shelf life and stability, and is easy to manufacture, ship, store, and handle. In certain embodiments, the rupturable container protects the moisture-curable composition from moisture, and also protects a user of the adhesive article from the moisture-curable composition. Further, the acid halide component prevents premature reaction of the moisture-curable composition with moisture, i.e., water, and imparts the moisture-curable composition with the ability to provide excellent adhesion strength after curing. In certain embodiments, the seam of the rupturable container ruptures under pressure, which promotes uniform distribution of the moisture-curable composition, thereby providing excellent adhesion strength.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial perspective view of a series of adhesive articles of the present invention;

FIG. 2 is a cross-sectional end view taken along line 2-2 of FIG. 1;

FIG. 3 is a cross-sectional end view of another embodiment of the adhesive article of the present invention;

FIG. 4 is a cross-sectional end view of another embodiment of the adhesive article of the present invention;

FIG. 5 is a perspective view of a series of adhesive articles of the present invention disposed on top of a pair of floor joists;

FIG. 6 is a perspective view of a series of adhesive articles partially disposed within a pouch; and

FIG. 7 is a perspective view of a series of adhesive articles partially disposed within a bucket.

### DETAILED DESCRIPTION OF THE INVENTION

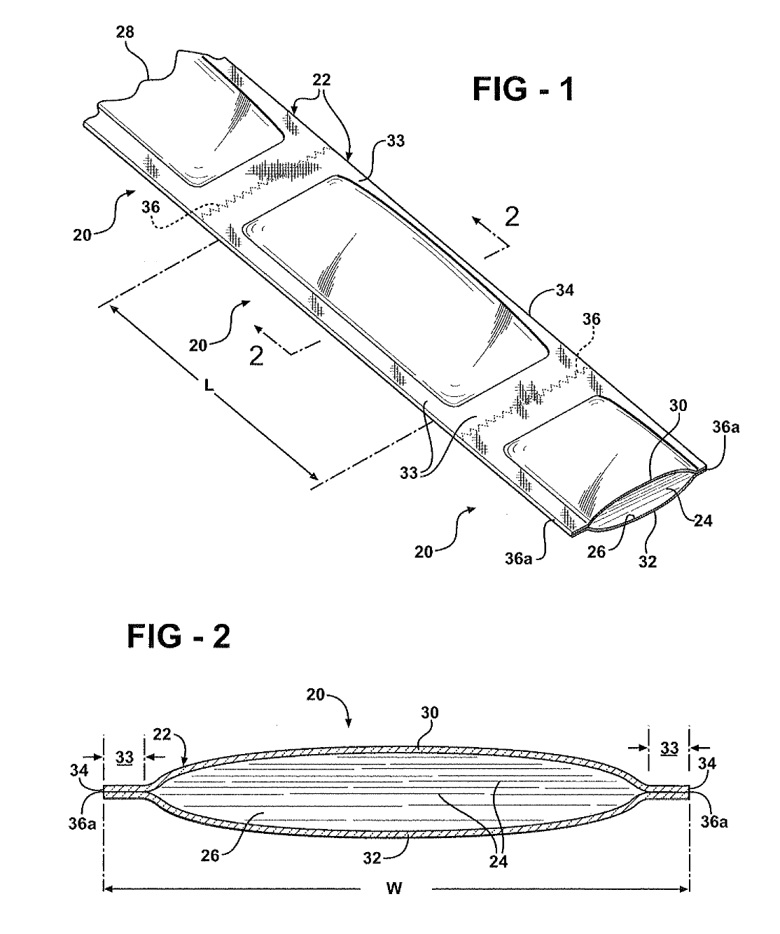

Referring to the Figures, wherein like numerals indicate like parts throughout the several views, an adhesive article is shown generally at 20 in FIGS. 1 through 7. The adhesive article 20, hereinafter referred to as the article 20, may be used in various industries and for various applications. It is contemplated that the article 20 could be used in any and all adhesive applications that involve adhering one substrate to another. For example, the article 20 may be used in aerospace applications, electrical/electronic applications, appliance applications, automotive OEM applications, textile applications, footwear applications, packaging applications, construction applications, consumer applications, abrasives applications, bookbonding/binding applications, furniture applications, pressure-sensitive applications, primary woodbonding applications, and any other non-reversible adhesive application. The article 20 of the present invention is especially useful for construction and remodeling of commercial, industrial, and residential buildings due to the excellent adhesion strength provided by the article 20, and due to other physical properties of the article 20, which are described in further detail below. For example, the article 20 may be used on floor joists 40, which is illustrated in FIG. 5 and described in further detail below.

The article 20 comprises a rupturable container 22 and a moisture-curable composition 24 disposed therein. The rupturable container 22 defines an enclosed cavity 26. As best shown in FIGS. 2 through 4, the moisture-curable composition 24 is disposed within the enclosed cavity 26. Typically, the moisture-curable composition 24 substantially fills the enclosed cavity 26; however, some void space may remain within the enclosed cavity 26, such as head space (e.g. an air bubble).

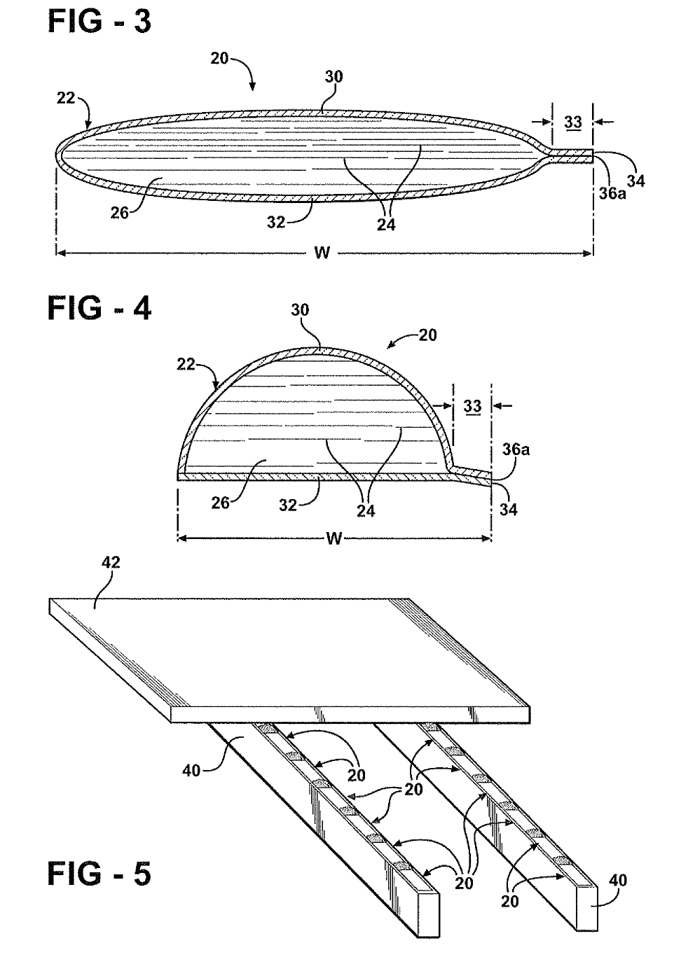

In one embodiment, as best shown in FIGS. 2 and 4, the rupturable container 22 includes a first layer 30 and a second layer 32 opposite the first layer 30. In this embodiment, the layers 30, 32 are affixed along an outer peripheral portion 33 extending between an edge 34 (i.e., an outer edge 34) and the enclosed cavity 26 of the rupturable container 22. However, in other embodiments and as alluded to above, the rupturable container 22 may define two or more enclosed cavities 26 (not shown). The rupturable container 22 typically includes at least one seam 36 defined in at least a portion of the outer edge 34. It is to be appreciated that the seam 36 may be located elsewhere on the rupturable container 22, such as in the first layer 30 and/or the second layer 32. In other words, the seam 36 may be at least one of a side-seam 36a as best shown in FIG. 2, an end-seam, a back-seam, or a top-seam (not shown). In one embodiment, as shown in FIG. 2, the rupturable container 22 includes two side seams 36a. In this embodiment, the rupturable container 22 may generally mimic configuration of a condiment container. In another embodiment, as shown in FIG. 3, the rupturable container 22 includes one side seam 36a. Specifically, in this embodiment, the rupturable container 22 has a unitary layer (designated as 30 and 32) affixed along an outer peripheral portion 33 extending between an edge 34 and the enclosed cavity 26 of the rupturable container 22. In this embodiment, the rupturable container 22 may generally mimic configuration of a straw-wrapper. In yet another embodiment, as shown in FIG. 4, the rupturable container 22 includes two side seams 36a, and the top layer 30 of the rupturable container 22 generally has a dome configuration. In a similar embodiment, the rupturable container 22 may also include just one side seam 36a. In other embodiments (not shown), the rupturable container 22 may include three or more seams 36, such as one side seam 36a, and a seam, or seams, disposed in the first layer 30 and/or the second layer 32.

The layers 30, 32 are typically formed from a plastic material, a combination of two or more plastic materials, or a combination of two or more plastic materials and two or more inorganic materials. The plastic material may comprise any plastic known in the polymeric art. Typically, the plastic material is selected to be compatible with the moisture-curable composition 24. The first and second layers 30, 32 may be uniform in thickness or thickness may vary from position to position within the first and/or second layers 30, 32. In one embodiment, the thickness of at least one region in at least one of the first and second layers 30, 32 is reduced in thickness to facilitate rupture of the layer 30, 32 in that region. In this embodiment, reduction in thickness may be achieved by scoring, casting, or molding, the layer 30, 32, similar to methods used in making air bag covers to promote ease of rupture of the layer 30, 32.

In one embodiment, the plastic material comprises thermoplastic polyurethane (TPU) elastomer. TPU is generally a block copolymer. TPU's can be formed from diisocyanates, polyols and short chain diols, e.g. 1,4-Butanediol, as chain extenders. The diisocyanate can be either an aromatic and/or an aliphatic isocyanate. A common example is 4,4′-diphenylmethane diisocyanate, such as Lupranate® M from BASF Corporation. The polyols can be polyether polyols, such as polytetramethylene ether glycol (PTMEG) (e.g. polyTHFs available from BASF Corporation); polyester polyols; and/or polyols with both ether and ester linkages in the polyol backbones. Based on the end application requirements, different additives can be added during the TPU manufacturing process. Examples of suitable additives include waxes, lubricants, UV additives, flame retardants, etc.

In general, TPU has excellent abrasion resistance, excellent mechanical properties, and good low temperature flexibility. Polyester based TPUs generally have good chemical resistance and polyether based TPUs generally have good microbial and hydrolysis resistance. TPU can be processed by conventional extrusion or injection methods to different end shapes, such as films. Elastollan 1185A10V film, from BASF Corporation, is a common grade of TPU film processed by either a blown film process or a flat-die extrusion process. TPU is relative tacky material compared to other common plastic materials, such as polystyrene, polyamide, polyethylene, polypropylene etc. One way to address this issue is to add a wax, a lubricant, and/or an inorganic filler to reduce the tackiness. Elastollan WY09290 and Elastollan WY09090, from BASF Corporation, are special grades of TPU to address this “tackiness” issue. These two grades are especially useful for forming the rupturable container 22 of the present invention.

In another embodiment, the plastic material comprises biaxially-oriented polyethylene terephthalate (boPET) polyester, e.g. Mylar®. In a further embodiment, the plastic material comprises a polyolefin, such as polyethylene (PE) or polypropylene (PP). Other suitable materials, for purposes of the present invention, include, but are not limited to, polyethylene terephthalate (PET) copolyester, such as Hytrel from DuPont; Artinel from DSM, and Easttar from Eastman; Metallocene polyolefins (POE), such as Exact from ExxonMobil, and Flexomer and Engage from Dow; thermoplastic olefins (TPO), such as Hi-fax from Basell, Dexflex, Dexpro from SolVay, and Telcar from Teknor Apex; Styrenic Block Copolymers (SBC), such as Kraton from Kraton, Versaflex and Dynaflex from GLS, etc.; polyvinyl chlorides (PVC); and compounded plastic materials, such as TPU compounded with SBC, SEBS, PVC, a polyolefin, TPO, polyamide, ABS, etc. In certain embodiments, the first and/or second layers 30, 32 can comprises a combination of different plastic materials present in two or more separate sub-layers, e.g. laminations, within the first and/or second layers 30, 32. In other embodiments, as alluded to above, the first and/or second layers 30, 32 comprise mixture of two or more plastic materials, e.g. copolymers, mixtures, or blends. In certain embodiments, such as those employing the side stream 36a, the rupturable container 22 can include a layer of an adhesive (not shown) to seal the outer edge 34. If employed, the adhesive typically comprises a thermoplastic adhesive. The thermoplastic adhesive can be thermally activated to bond the first and second layers 30, 32 of the rupturable container 22.

In certain embodiments at least one of the layers 30, 32 may comprise an inorganic material, such as a flexible metallic material. The flexible metallic material may comprise, for example, aluminum, vapor or liquid deposited aluminum, aluminum alloy foil, or vapor or liquid deposited aluminum alloy. The layers 30, 32 may comprise a metallic layer laminated with a plastic, and/or a metallized plastic. Various materials may be used in the layers 30, 32, such as moisture barriers and plating materials, e.g. aluminum oxide, clays, etc.

In one embodiment, the layers 30, 32 are both formed from TPU film. In the aforementioned embodiment, the layers 30, 32 may be slightly permeable to moisture. Preferably, the layers 30, 32 do not interfere with adhesion strength provided by the article 20 between two or more objects once the rupturable container 22 is ruptured. Without being bound or limited by any particular theory, it is believed that TPU film is useful since it is the TPU film is chemically similar to the moisture-curable composition 24, i.e., a “like-likes-like” scenario. Suitable grades of TPU are commercially available from BASF Corporation of Florham Park, N.J.

In certain embodiments, such as those employing the TPU film to form the rupturable container 22, the TPU elastomer is selected from the group of polyether-based thermoplastic polyurethanes, polyester-based thermoplastic polyurethanes, and combinations thereof. By “based”, it is meant that at least one of the components employed to form the TPU elastomer includes polyether and/or polyester, typically, as a portion of an isocyanate-reactive component (e.g. a polyether polyol, a polyester polyol, etc.) as described and exemplified above with description of the TPU elastomer.

In certain embodiments employing the TPU elastomer, the TPU elastomer typically has an ultimate tensile strength of from about 30 to about 60, from typically from about 34.5 to about 52, and most typically about 34.5, MPa, according to ASTM D-412. If employed, the TPU elastomer typically has an elongation at break of from about 450 to about 600, more typically from about 500 to about 570, and most typically about 500, %, according to ASTM D-412. If employed, the TPU elastomer has a tear strength of from about 75 to about 125, more typically from about 88 to about 114, and most typically from about 101 to about 114, N/mm, according to ASTM D-624, Die C. In the aforementioned embodiments, physical properties of the TPU elastomer as described above impart similar properties to the rupturable container 22 formed therefrom, which is useful for protecting the moisture-curable composition 24 and for robustness of the article 20.

Other examples of suitable plastic materials, for purposes of the present invention, include, but are not limited to, polyethylene terephthalate (PET), polyvinylchloride (PVC), cellulose acetate (CA), polyvinylidene chloride (PVDC), polystyrene (PS), and polychlorotrifluoroethylene (PCTFE). It is to be appreciated that the rupturable container 22 may include any combination of two or more of the aforementioned plastic materials. The plastic material of the rupturable container 22 may be selected based upon what type of the moisture-curable composition 24 is employed, which is described in further detail below.

Each of the layers 30, 32 may be the same as or different from each other. For example, the first layer 30 may have a thickness less than or greater than a thickness of the second layer 32, and/or may be formed from a different material. Typically, the layers 30, 32, each individually have a thickness of from about 0.1 to about 10, more typically from about 1 to about 5, and most typically from about 1.5 to about 3.5, mils. The selection of thickness will depend upon the strength of the material comprising the layer 30, 32, the size of the enclosure, the degree of chemical barrier required, and other factors to be adjusted for based on end application of the article 20. In one embodiment, as best shown in FIG. 3, the layers 30, 32 are formed from the same plastic material, i.e., the layers 30, 32 are actually formed from one sheet, such that the rupturable container 22 is unitary. In other embodiments (not shown), the rupturable container 22 is formed from two or more initially discrete layers 30, 32, such as a layer of TPU and a layer of boPET. The layers 30, 32 can be joined together by various methods and/or apparatuses, depending on the specific method and/or apparatus employed to make the article 20, which is further described below. The layers 30, 32 are typically affixed along at least a portion of the outer edge 34 by application of heat; however the layers 30, 32 may also or alternatively be affixed by application of an adhesive, ultrasonic energy, and/or pressure. If employed, suitable adhesives for affixing the outer edge 34 include, but are not limited, adhesives curable by application of IR light, UV light, and/or other energy sources. Other conventional adhesives can also be employed, such as a wax. The layers 30, 32 impart the article 20 with flexibility and protection for the moisture-curable composition 24. Specifically, in certain embodiments, described in further detail below, the rupturable container 22 protects the moisture-curable composition 24 from exposure to moisture, i.e., the rupturable container 22 serves as a vapor barrier to prevent the moisture-curable composition 24 from prematurely curing prior to use. In certain embodiments, the rupturable container 22 serves as a UV-light and/or visible-light barrier. In addition, the rupturable container 22 protects a user of the article 20 from the moisture-curable composition 24 disposed therein.

By “rupturable”, it is meant that the rupturable container 22 ruptures under pressure. In other words, the rupturable container 22 can rupture (or burst) under various magnitudes of pressure. For example, the rupturable container 22 can rupture under weight of a building component, e.g. a floor panel, under weight of a user, e.g. a contractor, or can rupture by a fastener driven (i.e., piercing) into the rupturable container 22. Examples of such fasteners include nails, staples, and screws. Since fasteners are commonly used for construction and remodeling projects, the article 20 is especially suited for use where the article 20 will be punctured by one or more fasteners to expedite exposure of the moisture-curable composition 24 to the ambient environment, such as expediting exposure of the moisture-curable composition 24 to moisture. Not only does this ensure that the moisture-curable composition 24 will be exposed to the ambient environment in order to cure, but this also insures that any squeaking that can arise from the fastener rubbing on the building component is minimized. Specifically, the moisture-curable composition 24 can encapsulate at least a portion of the fastener to prevent rubbing and squeaking of the fastener on the building component. It is to be appreciated that the rupturable container 22 can rupture at one or more locations when exposed to pressure. For example, the rupturable container 22 can rupture at one or more points on one of or both of the layers 30, 32, such as from fastener puncture points, or can rupture along one or more locations along the outer edge 34, i.e., the seam 36, such as from the weight of the contractor walking on top of the article 20. The seam 36 or seams 36 is especially useful for uniformly distributing the moisture-curable composition 24 when the rupturable container 22 ruptures.

The article 20 can rupture under various pressures, i.e., the article 20 can have various rupture strengths. The article 20 typically has a rupture strength of from about 1 to about 50, more typically from about 5 to about 35, pounds per square inch (psi). It is believed that rupture strength of the article 20 depends on configuration of the rupturable container 22 such as number of configuration of the seam 36 or seams 36, and material of the layers 30, 32. After the moisture-curable composition 24 cures, the article 20 typically provides adhesion strength between two or more objects, e.g. building components, of from about 25 to about 250, more typically from about 50 to about 200, and most typically from about 50 to about 150, psi. After the rupturable container 22 ruptures, cure time of the moisture-curable composition 24 is typically of from about 12 to about 48, more typically from about 12 to about 36, and most typically from about 12 to about 24, hours. By “cure time”, it is meant that the moisture-curable composition 24 is substantially cured to yield a bonded article comprising two or more objects with full adhesion strength.

Referring to FIGS. 1 and 5 through 7, a series of the article 20 may be joined in a continuous chain 28, specifically, in an end-to-end arrangement. The continuous chain 28 can be made by using a packaging method and/or apparatus known to those of ordinary skill in the packaging art, such as a method employed to package a condiment or a straw. For example, in one method of making the article 20, a sheet of plastic material, e.g. TPU film, is fed into a packaging apparatus, the moisture-curable composition 24 is fed onto the sheet, and the sheet is rolled upon itself and heat-sealed along a longitudinal edge to form the rupturable container 22 and the seam 36a. The rupturable container 22 is then heat-sealed and partially perforated along a series of lateral edges to define each of the articles 20 individually and to form the continuous chain 28, and optionally, additional seams 36, e.g. end-seams. While one method of making the article 20 has been described above, it is to be appreciated that the present invention is not limited to any particular method of making the article 20.

As best shown in FIG. 1, the articles 20 in the continuous chain 28 may be partially perforated along lateral edges 38 (shown in phantom). The lateral edges 38 allow for individual articles to be torn from the continuous chain 28, or for groups of two or more of the articles 20 to torn from the continuous chain 28, if desired. The lateral edges 38 can also define one or more of the seams 36, e.g. end-seams. The article 20 may be torn open at the lateral edges 38 to access the moisture-curable composition 24. For example, the rupturable container 22 can be torn open at one of the lateral edges 38 and the moisture-curable composition 24 can be squeezed out of the rupturable container 22. In another embodiment (not shown), a series of articles 20 are joined in a matrix, i.e., in an end-to-end and a side-by-side arrangement. For example, four of the articles 20 can be joined together in a two by two matrix, or eight of the articles 20 can be joined together in a two by four matrix. In this embodiment, the articles 20 in the matrix may also be partially perforated along lateral edges 38. Increasing the number of seams 36 generally increases distribution of the moisture-curable composition 24 when the rupturable container 22 or, for example, the rupturable containers 22 of the continuous chain 28 rupture. It is believed that configuration of the rupturable containers 22 allows for flexibility in controlling distribution of the moisture-curable composition 24 upon rupture of the rupturable container 22. For example, many smaller rupturable containers 22 may in effect, be built in redundancy of the continuous chain 28, for allowing uniform distribution of the moisture-curable composition 24.

The article 20 is typically configured to mimic at least one dimension or an area of a building component, such as a width of a floor joist, e.g. the rupturable container 22 can be about 2 inches in width. As shown in FIG. 1, the rupturable containers 22 are rectangular in shape. As best shown in FIG. 3, the rupturable containers 22 are less than a width of a floor joist 40, which can facilitate uniform distribution of the moisture-curable composition 24 when the rupturable container 22 ruptures along the seam 36. While a few possible configurations of the rupturable container 22 are shown in the Figures and described and exemplified herein, the rupturable container 22 may be configured into other sizes, shapes, and configurations. For example, the rupturable container 22 may be in the form of a blister pack, a frangible capsule, etc. As another example, the rupturable container 22 can have a length L to width W ratio of from about 1:1 to about 12:1. Decreasing the length L and/or the width W of the article 20 generally increases uniform distribution of the moisture-curable composition 24 when the rupturable container 22 or, for example, the rupturable containers 22 of the continuous chain 28 rupture relative to longer lengths L and/or wider widths W.

The moisture-curable composition 24 comprises a prepolymer comprising the reaction product of an isocyanate component and an isocyanate-reactive component. In addition, the moisture-curable composition 24 further comprises a catalyst component and an acid halide component. The moisture-curable composition 24, hereinafter referred to as the composition 24, is described in further detail below. In one embodiment, the layers 30, 32 of the rupturable container 22 are formed from TPU film and the composition 24 is disposed in the enclosed cavity 26.

The isocyanate component is typically an organic polyisocyanate having two or more functional groups, e.g. two or more NCO functional groups. Suitable organic polyisocyanates, for purposes of the present invention include, but are not limited to, conventional aliphatic, cycloaliphatic, araliphatic and aromatic isocyanates.

In certain embodiments, the isocyanate component is selected from the group of diphenylmethane diisocyanates (MDIs), polymeric diphenylmethane diisocyanates (pMDIs), and combinations thereof. In one embodiment, the isocyanate component comprises a pMDI and a MDI. It is believed that this embodiment is useful for increasing a cross-link density of the composition 24 after reacting with moisture, and therefore provides excellent adhesion strength between two or more objects after the composition 24 cures between the two or more objects. The pMDI and the MDI are typically present in the isocyanate component in a weight ratio (pMDI:MDI) of from about 1:1 to about 3:1, more typically from about 1:1 to about 2:1. If the embodiments with the pMDI and the MDI are employed, it is to be appreciated that the pMDI and the MDI may be added together or individually to make the prepolymer, and therefore the composition 24. Examples of other suitable isocyanates, for purposes of the present invention, include toluene diisocyanates (TDIs), hexamethylene diisocyanates (HDIs), isophorone diisocyanates (IPDIs), and combinations thereof.

In another embodiment, the isocyanate component is an isocyanate-terminated prepolymer. The isocyanate-terminated prepolymer is a reaction product of an isocyanate and a polyol and/or a polyamine. The isocyanate may be any type of isocyanate known to those skilled in the polyurethane art, such as one of the organic polyisocyanates previously described above. If employed to make the isocyanate-terminated prepolymer, the polyol is typically selected from the group of ethylene glycol, diethylene glycol, propylene glycol, dipropylene glycol, butane diol, glycerol, trimethylolpropane, triethanolamine, pentaerythritol, sorbitol, biopolyols, such as soybean oil, castor-oil, soy-protein, rapeseed oil, etc., and combinations thereof. If employed to make the isocyanate-terminated prepolymer, the polyamine is typically selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof.

Specific examples of suitable isocyanate components, for purposes of the present invention, include LUPRANATE® M, LUPRANATE® ME, LUPRANATE® MI, and LUPRANATE® M20S, all commercially available from BASF Corporation of Florham Park, N.J. Typically, the isocyanate component is present in an amount of from about 25 to about 60, more typically from about 30 to about 50, and most typically from about 35 to about 45, parts by weight, based on 100 parts by weight of the composition 24. It is to be appreciated that the isocyanate component may include any combination or two of more of the aforementioned isocyanates and isocyanate-terminated prepolymers.

The isocyanate-reactive component generally has one or more functional groups that are reactive with the isocyanate component, such as hydroxyl functional groups, amine functional groups, and/or amide functional groups. Examples of suitable isocyanate-reactive components, for purposes of the present invention, include alcohols, amines, and amides. The isocyanate-reactive component typically has a nominal functionality of from about 2 to about 8, and more typically from about 2 to about 6. By “nominal functionality”, it is meant that the functionality is based upon the functionality of an initiator molecule, rather than the actual functionality of the isocyanate-reactive component after manufacture. Without being limited to any particular theory, it is believed that a higher nominal functionality, i.e., a nominal functionality of about 3 or more, is useful for increasing a cross-link density of the composition 24 after reacting with moisture, and therefore provides excellent adhesion strength between two or more objects, after the composition 24 cures between the two or more objects. Typically, the isocyanate-reactive component has a hydroxyl number of from about 25 to about 300, more typically from about 25 to about 100, and most typically from about 25 to about 80, mg KOH/g. It is believed that polyols having lower hydroxyl numbers generally provide compositions 24 that are less brittle than polyols having higher hydroxyl numbers.

In one embodiment, the isocyanate-reactive component comprises a polyol having at least two hydroxyl functional groups reactive with the isocyanate component. The polyol may be the same as or different than the polyol previously described above. The isocyanate-reactive component can comprise a polyester polyol, a polyether polyol, and combinations thereof. Further, the polyol can be selected from the group of, but is not limited to, aliphatic polyols, cycloaliphatic polyols, aromatic polyols, heterocyclic polyols, and combinations thereof. More specific examples of suitable polyols are selected from the group of, but are not limited to, propylene glycols, sucrose-initiated polyols, sucrose/glycerine-initiated polyols, trimethylolpropane-initiated polyols, biopolyols, and combinations thereof. In one embodiment, when the isocyanate component comprises the pMDI and the MDI, the isocyanate-reactive component typically comprises the polyol having at least two hydroxyl functional groups reactive with the isocyanate component. In this embodiment, the pMDI is typically present in the isocyanate component in excess relative to the MDI present in the isocyanate component, e.g. in a weight ratio (pMDI:MDI) of about 1.25:1 or greater. Without being limited to any particular theory, it is believed that having at least two hydroxyl functional groups reactive with the isocyanate component is useful for providing excellent adhesion strength between two or more objects, after the composition 24 cures between the two or more objects.

In one specific embodiment, the isocyanate-reactive component comprises a polypropylene glycol. In this embodiment, the polypropylene glycol typically has a hydroxyl number of from about 50 to about 60 mg KOH/gm. A specific example of a suitable polypropylene glycol is one having a nominal functionality of about 2 and a hydroxyl number of from about 53.4 to about 58.6 mg KOH/gm, commercially available from BASF Corporation of Florham Park, N.J. Without being limited to any particular theory, it is believed that the nominal functionality and the hydroxyl number of the specific polypropylene glycol set forth above imparts the composition 24 with excellent flexibility after reacting with moisture and curing, which is useful for compensating for expansion and contraction of, for example, building components that the article 20 is used to adhere. Typically, the isocyanate-reactive component is present in an amount of from about 35 to about 75, more typically from about 45 to about 65, and most typically from about 50 to about 65, parts by weight, based on 100 parts by weight of the composition 24. It is to be appreciated that the isocyanate-reactive component may include any combination of two or more of the aforementioned isocyanate-reactive components, e.g. two or more different polyols.

The isocyanate component and the isocyanate-reactive component are typically reacted in an amount at an isocyanate component to isocyanate-reactive component ratio of from about 15 to about 2, more typically from about 10 to about 2, and most typically from about 8 to about 2, to form the prepolymer. It is to be appreciated that the prepolymer may be made prior to making the composition 24 and/or made while making the composition 24. In other words, the isocyanate component and the isocyanate-reactive component may be reacted prior to and/or during formation of the composition 24.

The catalyst component catalyzes the reaction of the isocyanate-reactive component and the isocyanate component to make the prepolymer, and further catalyzes the reaction of the composition 24 and moisture, once the rupturable container 22 is ruptured. In one embodiment, the catalyst component is an organometallic catalyst. In this embodiment, the catalyst component typically includes at least one of, but is not limited to, tin, iron, lead, bismuth, mercury, titanium, hafnium, zirconium, and combinations thereof.

In one embodiment, the catalyst component comprises a tin catalyst. Suitable tin catalysts, for purposes of the present invention, include tin(II) salts of organic carboxylic acids, e.g. tin(II) acetate, tin(II) octoate, tin(II) ethylhexanoate and tin(II) laurate. In one embodiment, the organometallic catalyst comprises a dibutyltin dilaurate, which is a dialkyltin(IV) salt of an organic carboxylic acid. A specific example of a suitable organometallic catalyst, for purposes of the present invention, is DABCO® T-12, a dibutyltin dilaurate, which is commercially available from Air Products and Chemicals, Inc. of Allentown, Pa. The organometallic catalyst can also comprise other dialkyltin(IV) salts of organic carboxylic acids, such as dibutyltin diacetate, dibutyltin maleate and dioctyltin diacetate.

Examples of other suitable catalysts, for purposes of the present invention, include iron(II) chloride; zinc chloride; lead octoate; tris(dialkylaminoalkyl)-s-hexahydrotriazines including tris(N,N-dimethylaminopropyl)-s-hexahydrotriazine; tetraalkylammonium hydroxides including tetramethylammonium hydroxide; alkali metal hydroxides including sodium hydroxide and potassium hydroxide; alkali metal alkoxides including sodium methoxide and potassium isopropoxide; and alkali metal salts of long-chain fatty acids having from 10 to 20 carbon atoms and/or lateral OH functional groups.

Further examples of other suitable catalysts, specifically trimerization catalysts, for purposes of the present invention, include N,N,N-dimethylaminopropylhexahydrotriazine, potassium, potassium acetate, N,N,N-trimethyl isopropyl amine/formate, and combinations thereof. A specific example of a suitable trimerization catalyst is POLYCAT® 41, commercially available from Air Products and Chemicals, Inc. of Allentown, Pa.

Yet further examples of other suitable catalysts, specifically tertiary amine catalysts, for purposes of the present invention, include dimethylaminoethanol, dimethylaminoethoxyethanol, triethylamine, N,N,N′,N′-tetramethylethylenediamine, N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzylamine, trimethyl amine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (DMCHA), N,N,N′,N′,N″-pentamethyldiethylenetriamine, 1,2-dimethylimidazol, 3-(dimethylamino) propylimidazole, and combinations thereof. Specific examples of suitable tertiary amine catalysts are POLYCAT® 18 and POLYCAT® 1058, both of which are commercially available from Air Products and Chemicals, Inc. of Allentown, Pa. The catalyst component is typically present in an amount of from about 0.01 to about 2.5, more typically from about 0.05 to about 1, and most typically from about 0.05 to about 0.5, parts by weight, based on 100 parts by weight of the composition 24. It is to be appreciated that the catalyst component may include any combination of two or more of the aforementioned catalysts.

It is believed that the acid halide component generally blocks basic centers in the prepolymer, which prevents premature reaction/curing of the composition 24, when exposed to moisture. Specifically, when the composition 24 is exposed to moisture, a molecule of water reacts with an isocyanate (NCO) functional group present of the prepolymer to form an amine carbonate which decomposes to yield an amine. Without being limited to any particular theory, it is believed that the amine group further reacts to yield products that are basic in nature, such as ureas. These basic products contribute to instability by promoting additional reactions with the remaining NCO functional groups in the composition 24. The acid halide component stabilizes the composition 24 by preferentially reacting with these basic products. During application of the composition 24, the acid halide component is overwhelmed with amine functional groups formed from a multitude of water molecules reacting with a multitude of NCO functional groups present in the composition 24, such as when the rupturable container 22 is ruptured and exposed to excessive moisture. In other words, the acid halide component is “flooded” with excess water molecules, and therefore resulting amine functional groups, to a point where the acid halide component is completely or substantially reacted, i.e., “used up”. At this point, any remaining amine functional groups are free to react with any remaining NCO functional groups of the composition 24, thus cross-linking and eventually leading to curing of the composition 24. Prior to the composition 24 reacting with moisture, the prepolymer typically has a free NCO functional group content of at least about 5, more typically of from about 5 to about 25, and most typically from about 7.5 to about 20, parts by weight, based on 100 parts by weight of the prepolymer. Those skilled in the art appreciate that the free NCO group content is imparted by left over NCO functional groups imparted by the isocyanate component after reacting a portion of the NCO functional groups with the isocyanate-reactive component.

In addition to blocking basic centers present in the composition 24, and without being bound or limited by any particular theory, it is believed that the acid halide component also passivates the catalyst component, yielding a composition 24 with excellent storage life. Specifically, the acid halide component inhibits catalyst-promoted self-reaction of NCO functional groups in the composition 24, preventing the formation of higher molecular weight oligomers, and the accompanying undesirable increase in viscosity and decrease in NCO content. While present in the composition 24, it is believed that the acid halide component affords a more stable composition 24 while still allowing adequate reaction with moisture during application of the composition 24, and adequate curing, which provides for excellent adhesion strength between two or more objects.

In one embodiment, the acid halide component comprises a haloformate. In this embodiment, the haloformate is preferably diethylene glycol bischloroformate (also referred to in the art as “DECF”), which is a polyfunctional acid halide; however, it is to be appreciated that other polyfunctional acid halides can also be used as the acid halide component, such as maleyl chloride, manonyl chloride, succinyl chloride, adipyl chloride, itaconyl chloride, benzene disulphonyl chloride, ethylene glycol bischloroformate, etc. In the aforementioned embodiment, diethylene glycol bischloroformate is preferred due to volatility characteristics imparted to the acid halide component, which is believed to be linked to a molecular weight of diethylene glycol bischloroformate. Specifically, the molecular weight of diethylene glycol bischloroformate imparts the acid halide component with lower volatility, relative to employing other lower molecular weight acid halides for the acid halide component. Lower volatility of the acid halide component is useful for decreasing manufacturing costs of the composition 24, and therefore, the article 20 of the present invention.

In another embodiment, the acid halide component comprises a carboxylic acid chloride. Suitable acid chlorides include benzoyl chloride, t-butyl benzoyl chloride and terephthaloyl chloride. In the aforementioned embodiment, preferred acid chlorides include those with relatively low volatility, for example t-butyl benzoyl chloride and terephthaloyl chloride. The acid halide component is typically present in an amount of from about 0.005 to about 1, more typically from about 0.01 to about 0.5, and most typically from about 0.01 to about 0.3, parts by weight, based on 100 parts by weight of the composition 24. It is to be appreciated that the acid halide component may include any combination of two or more of the aforementioned acid halides.

The catalyst component and the acid halide component are typically present in the composition 24 in a weight ratio (catalyst:acid halide) of from about 1:1 to about 4:1, more typically from about 1:1 to about 3:1, and most typically from about 1:1 to about 2:1. In certain embodiments, the catalyst component is dibutyltin dilaurate and the acid halide component is diethylene glycol bischloroformate, which are present in the composition 24 in the weight ratios (catalyst:acid halide) as previously described above. In these embodiments, the acid halide component is especially useful for passivating the catalyst component, until the composition 24 is exposed to excessive amounts of moisture, such as when the rupturable container 22 is ruptured.

The composition 24 may be prepared by combining the prepolymer, the catalyst component, and the acid halide component in any order. The catalyst component and/or the acid halide component may be added to form the composition 24 prior to, during, or after the reaction to form the prepolymer, i.e., prior to, during, or after introduction of the isocyanate component to the isocyanate-reactive component to make the prepolymer of the composition 24. In one embodiment to prepare the composition 24, the prepolymer is formed in the presence of the acid halide component, followed by addition of the catalyst component. The composition 24 typically has a viscosity of from about 2,000 to about 12,000, more typically from about 2,500 to about 10,000, cP at 25° C., according to ASTM D2196.

As described above, the acid halide component can prevent premature reaction of the composition 24, specifically premature reaction with moisture. Accordingly, the composition 24 and article 20 of the present invention have increased shelf life and stability, and are easier to manufacture, ship, store, and handle. Specifically, if moisture is present during manufacture and handling of the composition 24 and/or the article 20, the acid halide neutralizes any basic component that may be formed as a result of the reaction of moisture with the NCO functional groups present in the composition 24. The article 20 typically has a shelf life of at least about 6 months.

The article 20 of the present invention may be supplied to consumers for use by various means, typically in a secondary container, such as in large-sized drums, crates, boxes and containers or small-sized kits, pails, buckets, boxes, packets, and containers. Generally, the secondary container will afford more protection to the moisture-curable composition 24 relative to the rupturable container 22. In certain embodiments, such as those using the composition 24, the article 20 is preferably protected from moisture before the consumer uses the article 20 for the first time. The article 20 may also be protected from loss or moisture, loss of solvent, pressure, UV-light, and/or visible-light.

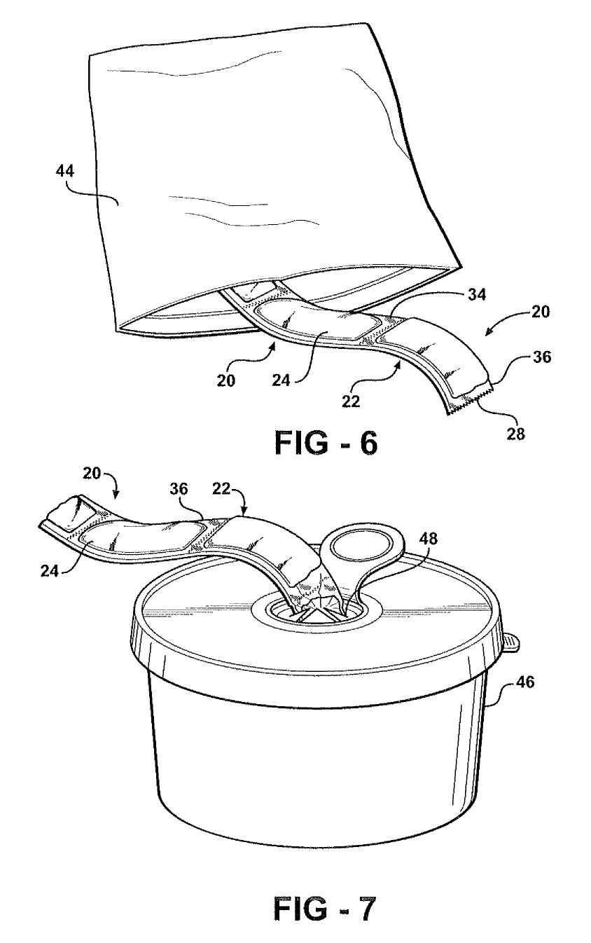

One specific example of a suitable secondary container for holding and protecting the article 20 is a pouch 44, as best shown in FIG. 6. The pouch 44 may be of various sizes, shapes, and configurations. The pouch 44 may be made of various materials, such as one or more of the plastic materials described and exemplified above with description of the rupturable container 22. In one embodiment, the pouch 44 is made of one or more layers comprising metallized polyester film. One example of such a pouch 44 is the DRI-SHIELD™ 2000 brand sold by Static Control Components of Sanford, N.C. In another embodiment, the pouch 44 comprises a laminated film comprising at least one layer of aluminum foil and at least one layer of structural material, e.g. paper, PET, PP, PE, nylon, or the like. The thickness of the aluminum foil layer or layers of the pouch 44 is selected to provide the desired degree of barrier protection to the article 20. Superior barrier function is achieved with aluminum foil that is at least about 0.25 mils thick, more typically at least about 0.3 mils thick, and most typically at least about 0.35 mils thick. Pouches 44 of this type are available from Beacon Converters, Saddle Brook, N.J. In many embodiments, the pouch 44 also comprises an adhesive thermoplastic “seal” layer comprising a thermally activated seal material which is thermally activated to bond edges of the film to form the pouch 44. One example of a suitable seal material is linear low density polyethylene (LLDPE). Others examples include low density polyethylene (LDPE) and Surlyn® from DuPont™. It is to be appreciated that other secondary containers may be employed rather than just the pouch 44.

In one embodiment, the article 20 is supplied in a bucket 46 (e.g. as shown in FIG. 7) or a box with an opening 48 for grabbing and using one or more of the articles 20 during use, the opening being re-sealable to increase life of the article 20. The bucket 46 or box may contain a desiccant inside, to absorb any ambient moisture in the secondary container.

Generally, a higher level of protection is needed to protect the article 20 from moisture during long-term storage and during transport to a consumer relative to a lower level of protection needed during use and storage of the article 20 by the consumer. For example, the pouch 44 may be provide diffusion barrier protection, which is substantially impermeable before first use of one or more of the articles 20 disposed therein by a consumer, and then the pouch 44 can be re-sealable thereafter between uses of one or more of the articles 20, such as re-sealable with a Ziploc type closure (not shown). In another embodiment the pouch 44 may be “airtight” before first use of one or more of the articles 20 disposed therein, and then left substantially open thereafter, such as the bucket 46 or box described above including a desiccant therein. In this embodiment the material of the rupturable container 22 provides protection during use of the article 20.

As described above, the article 20 is typically used for construction purposes. Specifically, the article 20 is used for adhesion purposes, such as adhering two or more building components together. Examples of building components that the article 20 can be used on include, but are not limited to, trusses, floor joists 40, roof joists, rafters, studs, and other building components known to those of ordinary skill in the construction art.

In one specific example of a method of using the article 20, floor panels 42, e.g. sub-flooring 42, may be laid over floor joists 40 during a construction project. As best shown in FIG. 3, one or more of the articles 20, such as the continuous chain 28, is placed upon the floor joists 40. A floor panel 42 is then placed on top the floor joists 40 with the article 20 sandwiched between the floor panel 40 and the floor joists 42. Pressure is applied to the rupturable container 22, which ruptures under pressure, and the composition 24 is exposed to the ambient environment. Upon exposure to moisture in the ambient environment, such as water in the air and/or water in the floor panel 40, the composition 24 begins to cure to form an adhesive bond between the floor panel 42 and the floor joist 40. In addition to adhesion purposes, the article 20 may also be useful for preventing squeaking and/or warping of building components, such as the floor panel 42. For example, the adhesive bond can serve as a cushion for the building component. In one embodiment, a layer of pressure sensitive adhesive (PSA) may be disposed on the rupturable container 22 for affixing the article 20 to a surface. This embodiment is especially useful for affixing the article 20 to angled surfaces, e.g. roof joists, roof rafters, and wall studs. The PSA may be any PSA known in the adhesive art, such as a silicone based PSA. The outer peripheral portion 33 can also be used to attach the article 20 to a surface, such as by drying a nail through the outer peripheral portion 33 to retain the article 20 in place. It is to be appreciated that the present invention is not limited to any particular use of the article 20.

The following examples, illustrating the adhesive articles of the present invention, are intended to illustrate and not to limit the invention.

### EXAMPLES

The moisture-curable composition to be disposed in the rupturable container of the adhesive article of the present invention is made by combining an isocyanate component, an isocyanate-reactive component, a catalyst component, and an acid halide component in a reaction vessel. The amount and type of each component used to form the moisture-curable composition is indicated in Table 1 below with all values in parts by weight based on 100 parts by weight of the moisture-curable composition on a pre-reaction weight basis unless otherwise indicated.

TABLE 1

| | Com- | | | | |
|---|---|---|---|---|---|
| | parative | Inventive | Inventive | Inventive | Inventive |
| Component | Example 1 | Example 1 | Example 2 | Example 3 | Example 4 |
| Isocyanate | 25.12 | 25.07 | 25.07 | 25.10 | 55.70 |
| A | | | | | |
| Isocyanate | 16.74 | 16.71 | 16.71 | 16.70 | 0.00 |
| B | | | | | |
| Isocyanate- | 58.14 | 58.02 | 58.00 | 58.10 | 43.30 |
| reactive A | | | | | |
| Isocyanate- | 0.00 | 0.00 | 0.00 | 0.00 | 0.90 |
| reactive B | | | | | |
| Acid Halide | 0.00 | 0.05 | 0.07 | 0.04 | 0.50 |
| Catalyst | 0.00 | 0.15 | 0.15 | 0.05 | 0.10 |

Isocyanate A is a polymeric diphenylmethane diisocyanate having an actual functionality of about 2.7 and an NCO content of about 31.5%, commercially available from BASF Corporation of Florham Park, N.J.

Isocyanate B is essentially a pure 4,4′-diphenylmethane diisocyanate having an actual functionality of about 2 and an NCO content of about 33.5%, commercially available from BASF Corporation of Florham Park, N.J.

Isocyanate-reactive A is a polypropylene glycol having an OH value of from about 50 to about 60 mg KOH/g, and a nominal molecular weight of about 2000, commercially available from BASF Corporation of Florham Park, N.J.

Isocyanate-reactive B is a triol having an OH value of from about 388 to about 408 mg KOH/g, and a nominal molecular weight of about 400, commercially available from BASF Corporation of Florham Park, N.J.

Acid Halide is diethylene glycol bischloroformate, commercially available from PPG Industries, Inc. of Pittsburgh, Pa.

Catalyst is dibutyltin dilaurate, commercially available from Air Products and Chemicals of Allentown, Pa.

Example 3 has a NCO group content of 11.0 based on 100 parts by weight of the Example 3 and a viscosity of 5,500 cP at 25° C. according to ASTM D2196. Example 4 has a NCO group content of 15.3 based on 100 parts by weight of the Example 4 and a viscosity of 8,900 cP at 25° C. according to ASTM D2196.

Each of the examples, more specifically, each of the moisture-curable compositions, are disposed in a rupturable container made of TPU film by heat sealing the moisture-curable compositions in respective rupturable containers to form the articles. The TPU film is from BASF Corporation. Adhesion testing is carried out on the articles according to ASTM D1623. Each of the articles, in duplicate, are placed on top a first piece of oriented strand board (OSB). A second piece of OSB is placed on top the articles and first piece of OSB. The pieces of OSB are clamped together to rupture the articles disposed in between the pieces of OSB such that the moisture-curable composition flows out to provide adhesion between the pieces of OSB. The pieces of OSB are clamped for 24 hours.

After such time, the clamp is removed, i.e., pressure is removed from the pieces of OSB. The samples for this test method comprise two 3″×3″ OSB samples that are glued together, firstly with the comparative adhesive and secondly with the inventive moisture-curable compositions, which are all encapsulated in the TPU film. These samples are then glued to metal clamps pertaining to an INSTRON using a strong epoxy glue as described in ASTM D1623. These specimens are then pulled apart using the INSTRON and are examined for either failure, partial failure, i.e., adhesive and cohesive failure combined, or cohesive failure, i.e., failure of the OSB sample and not that of the adhesive/moisture-curable composition. Partial or cohesive failure in almost all of the inventive examples indicates the strength of the inventive article is higher than that of the OSB itself.

Three additional examples of the article of the present invention are prepared. The articles are sandwiched between two pieces of OSB, as previously described above. The pieces of OSB are clamped together for 24 hours. After such time, the clamp is removed. Next, the sandwiched OSB pieces are adhered to a test plate. Upon testing of tensile adhesion strength, the piece of OSB on top of the sandwiched OSB pieces has cohesive, i.e., internal failure, during adhesion testing, as described above. The pieces of OSB on top of the sandwiched pieces have partial failure. Overall, all of the articles of the present invention provide excellent adhesion strength between the pieces of OSB, with the pieces of OSB failing prior to adhesion strength provided by the articles failing. Cohesive failure of the OSB indicates that the adhesion-strength using our articles of the present invention is adequate for various applications.

Many modifications and variations of the present invention are possible in light of the above teachings. The invention may be practiced otherwise than as specifically described within the scope of the appended claims.

What is claimed is:

1. An adhesive article comprising:
A) a rupturable container defining an enclosed cavity; and
B) a moisture-curable composition disposed within said enclosed cavity, said moisture-curable composition comprising
i) a prepolymer comprising the reaction product of
an isocyanate component, and
an isocyanate-reactive component,
ii) a catalyst component, and
iii) an acid halide component.

2. An adhesive article as set forth in claim 1 wherein said acid halide component iii) comprises a haloformate.

3. An adhesive article as set forth in claim 2 wherein said haloformate is diethylene glycol bischloroformate.

4. An adhesive article as set forth in claim 1 wherein said acid halide component iii) comprises a benzoyl halide.

5. An adhesive article as set forth in claim 4 wherein said benzoyl halide is t-butyl benzoyl chloride.

6. An adhesive article as set forth in claim 1 wherein said catalyst component ii) comprises an organometallic catalyst.

7. An adhesive article as set forth in claim 6 wherein said organometallic catalyst is a dibutyltin dilaurate.

8. An adhesive article as set forth in claim 1 wherein said catalyst component ii) and said acid halide component iii) are present in said moisture-curable composition B) in a weight ratio of from about 1:1 to about 4:1.

9. An adhesive article as set forth in claim 8 wherein said acid halide component iii) comprises a haloformate.

10. An adhesive article as set forth in claim 9 wherein said catalyst component ii) comprises an organometallic catalyst.

11. An adhesive article as set forth in claim 1 wherein said isocyanate component is selected from the group of polymeric diphenylmethane diisocyanates, diphenylmethane diisocyanates, toluene diisocyanates, hexamethylene diisocyanates, isophorone diisocyanates, and combinations thereof.

12. An adhesive article as set forth claim 1 wherein said isocyanate component comprises a polymeric diphenylmethane diisocyanate (pMDI) and a diphenylmethane diisocyanate (MDI).

13. An adhesive article as set forth in claim 1 wherein said isocyanate-reactive component comprises a polyol having at least two hydroxyl functional groups reactive with said isocyanate component.

14. An adhesive article as set forth in claim 13 wherein said polyol is a polypropylene glycol.

15. An adhesive article as set forth in claim 14 wherein said polypropylene glycol has a hydroxyl number of from about 50 to about 60 mg KOH/gm.

16. An adhesive article as set forth in claim 1 wherein said prepolymer i) has a free NCO functional group content of at least about 5% by weight based on 100 parts by weight of said prepolymer i).

17. An adhesive article as set forth in claim 1 wherein said moisture-curable composition B) has a viscosity of from about 5,000 to about 12,000 cP at 25° C. according to ASTM D2196.

18. An adhesive article as set forth in claim 1 wherein said rupturable container A) ruptures under pressure.

19. An adhesive article as set forth in claim 1 wherein said rupturable container A) includes a first layer and a second layer opposite said first layer with said layers affixed along an outer peripheral portion extending between an edge and said enclosed cavity of said rupturable container A).

20. An adhesive article as set forth in claim 1 wherein said rupturable container A) has a unitary layer affixed along an outer peripheral portion extending between an edge and said enclosed cavity of said rupturable container A).

21. An adhesive article as set forth in claim 1 wherein said rupturable container A) is formed from a plastic material selected from the group of polyethylenes, biaxially-oriented polyethylene terephthalate polyesters, polyolefins, polyethylene terephthalate copolyesters, metallocene polyolefins, thermoplastic olefins, styrenic block copolymers, polyvinyl chlorides, polyethylene terephthalates, polyvinylchlorides, cellulose acetates, polyvinylidene chlorides, polystyrenes, polychlorotrifluoroethylenes, and combinations thereof.

22. An adhesive article as set forth in claim 1 wherein said rupturable container A) is formed from a thermoplastic polyurethane (TPU) elastomer.

23. An adhesive article as set forth in claim 22 wherein said TPU elastomer is selected from the group of polyether-based thermoplastic polyurethanes, polyester-based thermoplastic polyurethanes, and combinations thereof.

24. An adhesive article as set forth in claim 22 wherein said TPU elastomer has an ultimate tensile strength of from about 30 to about 60 MPa according to ASTM D-412.

25. An adhesive article as set forth in claim 22 wherein said TPU elastomer has an elongation at break of from about 450 to about 600% according to ASTM D-412.

26. An adhesive article as set forth in claim 22 wherein said TPU elastomer has a tear strength of from about 75 to about 125 N/mm according to ASTM D-624, Die C.

27. An adhesive article as set forth in claim 22 wherein said rupturable container A) is formed from a film comprising said TPU elastomer.

28. An adhesive article as set forth in claim 27 wherein said film has a thickness of from about 0.1 to about 10 mils.

29. An adhesive article comprising:
A) a rupturable container defining an enclosed cavity, said rupturable container formed from a film comprising a thermoplastic polyurethane (TPU) elastomer; and,
B) a moisture-curable composition disposed within said enclosed cavity, said composition comprising
i) a prepolymer comprising the reaction product of
a polymeric diphenylmethane diisocyanate (pMDI),
a diphenylmethane diisocyanate (MDI), and
a polyol having at least two hydroxyl functional groups,
ii) a catalyst component comprising an organometallic catalyst, and
iii) an acid halide component.

30. An adhesive article as set forth in claim 29 wherein said organometallic catalyst and said acid halide component iii) are present in said moisture-curable composition in a weight ratio of from about 1:1 to about 4:1.

31. An adhesive article as set forth in claim 30 wherein said acid halide component iii) comprises a haloformate.

32. An adhesive article as set forth in claim 31 wherein said haloformate is diethylene glycol bischloroformate.

33. An adhesive article as set forth in claim 30 wherein said organometallic catalyst is a dibutyltin dilaurate.

34. An adhesive article as set forth in claim 29 wherein said polyol is a polypropylene glycol.

35. An adhesive article as set forth in claim 34 wherein said polypropylene glycol has a hydroxyl number of from about 50 to about 60 mg KOH/gm.

36. An adhesive article as set forth in claim 30 wherein said rupturable container A) ruptures under pressure.

37. An adhesive article as set forth in claim 29 wherein said TPU elastomer is selected from the group of polyether-based thermoplastic polyurethanes, polyester-based thermoplastic polyurethanes, and combinations thereof.

38. An adhesive article as set forth in claim 29 wherein said TPU elastomer has an ultimate tensile strength of from about 30 to about 60 MPa according to ASTM D-412.

39. An adhesive article as set forth in claim 29 wherein said TPU elastomer has an elongation at break of from about 450 to about 600% according to ASTM D-412.

40. An adhesive article as set forth in claim 29 wherein said TPU elastomer has a tear strength of from about 75 to about 125 N/mm according to ASTM D-624, Die C.

41. An adhesive article as set forth in claim 29 wherein said film has a thickness of from about 0.1 to about 10 mils.

42. An adhesive article as set forth in claim 29 wherein said rupturable container A) includes a first layer and a second layer opposite said first layer with said layers affixed along an outer peripheral portion extending between an edge and said enclosed cavity of said rupturable container A).

43. An adhesive article as set forth in claim 29 wherein said film is affixed along an outer peripheral portion extending between an edge and said enclosed cavity of said rupturable container A).
